(19) United States
(12) Patent Application Publication
(10) Pub. No.: US 2023/0027214 A1
(43) Pub. Date: Jan. 26, 2023

(54) ELECTRICALLY CONDUCTIVE FASTENERS

(71) Applicant: SAINT-GOBAIN PERFORMANCE PLASTICS PAMPUS GMBH, Willich (DE)

(72) Inventors: Jiri ZLEBEK, Nový Jicín (CZ); Hans-Juergen JAEGER, Huerth (DE); Daniel TOBIAS, Brno (CZ); Sebastian GIESEN, Viersen (DE)

(21) Appl. No.: 17/812,750

(22) Filed: Jul. 15, 2022

Related U.S. Application Data
(60) Provisional application No. 63/203,375, filed on Jul. 20, 2021.

(51) Int. Cl. H01R 4/64; F16B 21/07

(52) U.S. Cl. CPC H01R 4/64; F16B 21/075; F16B 2001/0064

(57) ABSTRACT

A push-on fastener including: a conductive, annular push-on fastener body including a major surface and a radial edge defining a peripheral surface, the push-on fastener body forming an aperture defining a central axis; and a non-conductive sliding layer overlying the major surface of the push-on fastener body, where the major surface includes a void area free of non-conductive sliding layer adapted to contact an inner component or an outer component so as to provide electrical conductivity between the push-on fastener and a neighboring component.

### CROSS-REFERENCE TO RELATED APPLICATION(S)

This application claims priority under 35 U.S.C. § 119(e) to U.S. Provisional Application No. 63/203,375, entitled “ELECTRICALLY CONDUCTIVE FASTENERS,” by Jiri ZLEBEK et al., filed Jul. 20, 2021, which is assigned to the current assignee hereof and incorporated herein by reference in its entirety.

### FIELD OF THE DISCLOSURE

This disclosure generally relates to fasteners and, in particular, to fastener having an electrical conduction path.

### BACKGROUND

Commonly, fasteners constrain relative movement to the desired motion and reduce friction between neighboring parts. One type fastener may be located in a gap between the outer surface of an inner component and the inner surface of the bore of an outer component within an assembly. Exemplary assemblies may include door, hood, tailgate, and engine compartment hinges, seats, steering columns, flywheels, driveshaft assemblies, or may include other assemblies notably those used in automotive applications. Sometimes, there exists a need to have certain electrical properties across components such as the inner component (such as a hinge piece) and the outer component (such as a neighboring hinge piece) in such an assembly. Therefore, there exists an ongoing need for improved fasteners that provide improved electrical properties while maintaining a longer lifetime of the assembly.

### BRIEF DESCRIPTION OF THE DRAWINGS

The present disclosure may be better understood, and its numerous features and advantages made apparent to those skilled in the art by referencing the accompanying drawings.

FIG. 1 includes a method of producing a push-on fastener in accordance with an embodiment;

FIG. 2A includes a cross-sectional view of a composite material that may form push-on fastener in accordance with an embodiment;

FIG. 2B includes a cross-sectional view of a composite material that may form a push-on fastener in accordance with an embodiment;

FIG. 2C includes a cross-sectional view a composite material that may form of a push-on fastener in accordance with an embodiment;

FIG. 3A includes top view illustration of a push-on fastener in accordance with an embodiment;

FIG. 3B includes side view illustration of a push-on fastener in accordance with an embodiment;

FIG. 4 includes a top perspective view of a push-on fastener within an assembly in accordance with an embodiment;

FIG. 5A is a top view of a push-on fastener in accordance with an embodiment;

FIG. 5B includes a side view of a push-on fastener within an assembly in accordance with an embodiment;

FIG. 5C includes a side view of a push-on fastener within an assembly in accordance with an embodiment;

FIGS. 6A, 6B, 6C and 6D are enlarged sectional end views of an embodiment of a layer structure of a push-on fastener, taken along the exemplary line 3-3 of FIG. 5B, showing uninstalled and installed configurations, respectively;

FIG. 7A is a top view of a push-on fastener in accordance with an embodiment;

FIG. 7B includes a side view of a push-on fastener within an assembly in accordance with an embodiment;

FIG. 7C includes a side view of a push-on fastener within an assembly in accordance with an embodiment;

FIG. 7D includes a side view of a push-on fastener within an assembly in accordance with an embodiment;

FIG. 8A a top view of a push-on fastener in accordance with an embodiment;

FIG. 8B includes a side view of a push-on fastener within an assembly in accordance with an embodiment;

FIG. 8C includes a side view of a push-on fastener within an assembly in accordance with an embodiment;

FIG. 9A is a top view of a push-on fastener in accordance with an embodiment;

FIG. 9B includes a side view of a push-on fastener within an assembly in accordance with an embodiment;

FIG. 9C includes a side view of a push-on fastener within an assembly in accordance with an embodiment;

FIG. 10A is a top view of a push-on fastener in accordance with an embodiment;

FIG. 10B includes a cut-away side view of a push-on fastener in accordance with an embodiment;

FIG. 10C includes a side view of a push-on fastener within an assembly in accordance with an embodiment;

FIG. 11A is a top view of a push-on fastener in accordance with an embodiment;

FIG. 11B includes a cut-away side view of a push-on fastener in accordance with an embodiment; and

FIG. 11C includes a side view of a push-on fastener within an assembly in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. The use of the same reference symbols in different drawings indicates similar or identical items.

### DESCRIPTION OF THE DRAWING(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the push-on fastener and push-on fastener assembly arts.

Embodiments described herein are generally directed to a push-on fastener and methods of creating and using a push-on fastener within an assembly. In particular embodiments, the push-on fastener may have an annular push-on fastener body including a major surface having a void area free of low friction layer.

Embodiments of the invention may include: A push-on fastener including: a conductive, annular push-on fastener body including a major surface and a radial edge defining a peripheral surface, the push-on fastener body forming an aperture defining a central axis; and a non-conductive sliding layer overlying the major surface of the push-on fastener body, where the major surface includes a void area free of non-conductive sliding layer adapted to contact an inner component or an outer component so as to provide electrical conductivity between the push-on fastener and a neighboring component.

Embodiments of the invention may further include: An assembly including: an outer component; an inner component; and a push-on fastener disposed between inner component and outer component, where the push-on fastener includes: a conductive, annular push-on fastener body including a major surface and a radial edge defining a peripheral surface, the push-on fastener body forming an aperture defining a central axis; and a non-conductive sliding layer overlying the major surface of the push-on fastener body, where the major surface includes a void area free of non-conductive sliding layer contacting the inner component or the outer component so as to provide electrical conductivity between the push-on fastener and at least one of the inner component or the outer component.

Embodiments of the invention may further include: An assembly including: an outer component; an inner component; and a push-on fastener disposed between inner component and outer component, where the push-on fastener includes a conductive, annular push-on fastener body including a major surface and a radial edge defining a peripheral surface, the push-on fastener body forming an aperture defining a central axis, and an electrically non-conductive sliding layer coupled to the major surface of the push-on fastener body, where the push-on fastener has an uninstalled configuration where the push-on fastener is electrically non-conductive, and an installed configuration where the push-on fastener is electrically conductive, where electrically non-conductive is defined as having an electrical resistivity value of greater than 10 Ω·m measured from the major surface of the push-on fastener to a second major surface of the push-on fastener along an axially extending line substantially parallel to the central axis.

Embodiments of the invention may further include: A method of forming and installing a push-on fastener, including: providing an inner component, and an outer component, and a push-on fastener that is electrically non-conductive, where the push-on fastener includes: a conductive, annular push-on fastener body including a major surface and a radial edge defining a peripheral surface, the push-on fastener body forming an aperture defining a central axis, and a non-conductive sliding layer overlying the major surface, where the major surface includes a void area free of non-conductive sliding layer; joining the push-on fastener to one of the inner and outer components to form a sub-assembly; and joining the other of the inner and outer components to the sub-assembly to form an assembly, and forming an electrically conductive path between the inner component, the push-on fastener, and the outer component, where electrically conductive is defined as having an electrical resistivity value of less than 10 Ω·m measured from the major surface of the push-on fastener to a second major surface of the push-on fastener along an axially extending line substantially parallel to the central axis.

Embodiments of the invention may further include: A method of forming a push-on fastener, including: providing a blank including an electrically conductive substrate, and an electrically non-conductive sliding layer coupled to the substrate; forming a plurality of projections in the blank; forming the blank into a push-on fastener including a conductive, annular push-on fastener body including a major surface and a radial edge defining a peripheral surface, and an electrically non-conductive sliding layer coupled to the major surface of the push-on fastener body; and removing sliding layer from the major surface to form a void area free of non-conductive sliding layer adapted to contact an inner component or an outer component so as to provide electrical conductivity between the major surface and a neighboring component.

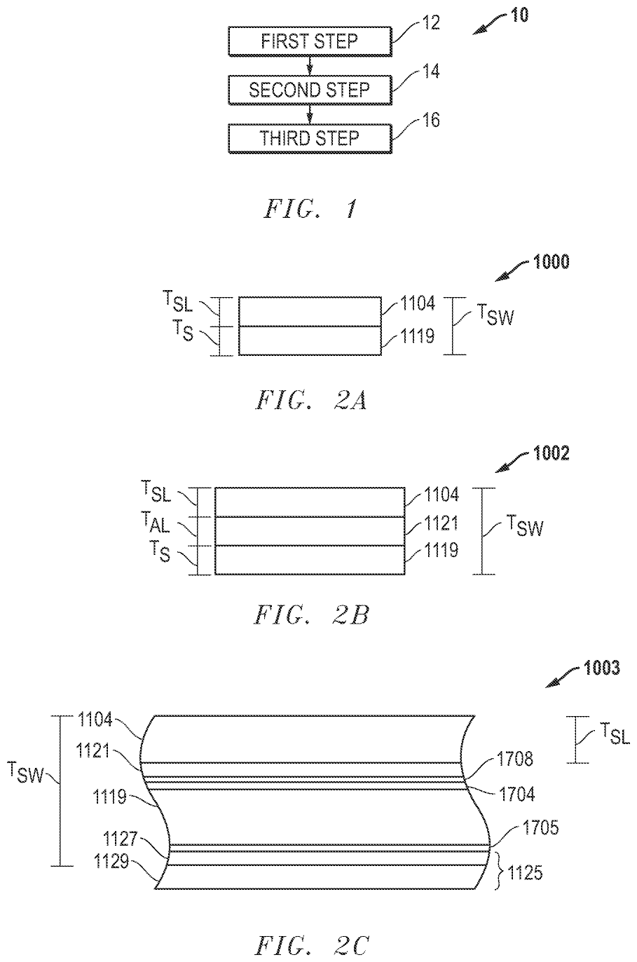

For purposes of illustration, FIG. 1 includes a method of producing a push-on fastener in accordance with an embodiment described above. The forming process 10 may include a first step 12 of providing a base material, a second step 14 of coating the base material with a low friction coating to form a composite material and a third step 16 of forming the composite material into a push-on fastener.

Referring to the first step 12, the base material may be a substrate. In an embodiment, the substrate can at least partially include a metal. According to certain embodiments, the metal may include iron, copper, titanium, tin, aluminum, alloys thereof, or may be another type of material. More particularly, the substrate can at least partially include a steel, such as, a stainless steel, carbon steel, or spring steel. For example, the substrate can at least partially include a 301 stainless steel. The 301 stainless steel may be annealed, ¼ hard, ½ hard, ¾ hard, or full hard. Moreover, the steel can include stainless steel including chrome, nickel, or a combination thereof. A particular stainless steel is 301 stainless steel. The substrate may include a woven mesh or an expanded metal grid. Alternatively, the woven mesh can be a woven polymer mesh. In an alternate embodiment, the substrate may not include a mesh or grid. The substrate may include conductive material.

In a number of embodiments, the substrate may be spring steel. The spring steel substrate can be may be annealed, ¼ hard, ½ hard, ¾ hard, or full hard. The spring steel substrate may have a tensile strength of not less than 600 MPa, such as not less than 700 MPa, such as not less than 750 MPa, such as not less than 800 MPa, such as not less than 900 MPa, or such as not less than 1000 MPa. The spring steel substrate may have a tensile strength of no greater than 1500 MPa, or such as no greater than 1250 MPa.

FIG. 2A includes an illustration of the composite material 1000 that may be formed according to first step 12 and second step 14 of the forming process 10 for producing a push-on fastener in accordance with an embodiment described above. For purposes of illustration, FIG. 2A shows the layer by layer configuration of a composite material 1000 after second step 14. In a number of embodiments, the composite material 1000 may include a substrate 1119 (i.e., the base material provided in the first step 12) and a low friction layer 1104 (i.e., the low friction coating applied in second step 14). As shown in FIG. 2A, the low friction layer 1104 can be coupled to at least a portion of the substrate 1119. In a particular embodiment, the low friction layer 1104 can be coupled to a surface of the substrate 1119 so as to form a low friction interface with another surface of another component. The low friction layer 1104 can be coupled to the radially inner surface of the substrate 1119 so as to form a low friction interface with another surface of another component. The low friction layer 1104 can be coupled to the radially outer surface of the substrate 1119 so as to form a low friction interface with another surface of another component.

In a number of embodiments, the low friction layer 1104 can include a low friction material. Low friction materials may include, for example, for example, a polymer, such as a polyketone, a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. In an example, the low friction layer 1104 includes a polyketone, a polyaramid, a polyimide, a polyetherimide, a polyamideimide, a polyphenylene sulfide, a polyphenylene sulfone, a fluoropolymer, a polybenzimidazole, a derivation thereof, or a combination thereof. In a particular example, the low friction/wear resistant layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction/wear resistant layer includes polyketone, such as polyether ether ketone (PEEK), polyether ketone, polyether ketone ketone, polyether ketone ether ketone, a derivative thereof, or a combination thereof. In an additional example, the low friction/wear resistant layer may be an ultra high molecular weight polyethylene. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. The low friction layer 1104 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, lead, iron, bronze, steel, spring steel, stainless steel), a metal alloy (including the metals listed), an anodized metal (including the metals listed) or any combination thereof. Fluoropolymers may be used according to particular embodiments. As used herein, a “low friction material” can be a material having a dry static coefficient of friction as measured against steel of less than 0.5, such as less than 0.4, less than 0.3, or even less than 0.2. A “high friction material” can be a material having a dry static coefficient of friction as measured against steel of greater than 0.6, such as greater than 0.7, greater than 0.8, greater than 0.9, or even greater than 1.0. The low friction layer 1104 may be an electrically non-conductive or low-conductive sliding material, e.g. includes a material that is non-conductive or low-conductive.

In a number of embodiments, the low friction layer 1104 may further include fillers, including glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof. Fillers can be in the form of beads, fibers, powder, mesh, or any combination thereof. The fillers may be at least 1 wt % based on the total weight of the low friction layer, such as at least 5 wt %, or even 10 wt % based on the total weight of the low friction layer.

The substrate 1119 can have a thickness Ts of between about 10 microns to about 1500 microns, such as between about 50 microns and about 1000 microns, such as between about 100 microns and about 750 microns, such as between about 350 microns and about 650 microns. In a number of embodiments, the substrate 1119 may have a thickness Ts of between about 700 and 800 microns. In a number of embodiments, the substrate 1119 may have a thickness Ts of between about 950 and 1050 microns. It will be further appreciated that the thickness Ts of the substrate 1119 may be any value between any of the minimum and maximum values noted above. The thickness of the substrate 1119 may be uniform, i.e., a thickness at a first location of the substrate 1119 can be equal to a thickness at a second location therealong. The thickness of the substrate 1119 may be non-uniform, i.e., a thickness at a first location of the substrate 1119 can be different from a thickness at a second location therealong.

In an embodiment, the low friction layer 1104 can have a thickness T_{SL} of between about 1 micron to about 500 microns, such as between about 10 microns and about 350 microns, such as between about 30 microns and about 300 microns, such as between about 40 microns and about 250 microns. In a number of embodiments, the low friction layer 1104 may have a thickness T_{SL} of between about 50 and 300 microns. It will be further appreciated that the thickness T_{SL} of the low friction layer 1104 may be any value between any of the minimum and maximum values noted above. The thickness of the low friction layer 1104 may be uniform, i.e., a thickness at a first location of the low friction layer 1104 can be equal to a thickness at a second location therealong. The thickness of the low friction layer 1104 may be non-uniform, i.e., a thickness at a first location of the low friction layer 1104 can be different from a thickness at a second location therealong. It can be appreciated that different low friction layers 1104 may have different thicknesses. The low friction layer 1104 may overlie one major surface of the substrate 119, shown, or overlie both major surfaces. The substrate 1119 may be at least partially encapsulated by the low friction layer 104. That is, the low friction layer 1104 may cover at least a portion of the substrate 119. Axial surfaces of the substrate 1119 may be exposed from the low friction layer 1104.

FIG. 2B includes an illustration of an alternative embodiment of the composite material that may be formed according to first step 12 and second step 14 of the forming process 10 for producing a push-on fastener in accordance with an embodiment described above. For purposes of illustration, FIG. 2B shows the layer by layer configuration of a composite material 1002 after second step 14. According to this particular embodiment, the composite material 1002 may be similar to the composite material 1000 of FIG. 2A, except this composite material 1002 may also include at least one adhesive layer 1121 that may couple the low friction layer 1104 to the substrate 1119 (i.e., the base material provided in the first step 12) and a low friction layer 1104 (i.e., the low friction coating applied in second step 14). In another alternate embodiment, the substrate 1119, as a solid component, woven mesh or expanded metal grid, may be embedded between at least one adhesive layer 1121 included between the low friction layer 1104 and the substrate 1119.

The adhesive layer 1121 may include any known adhesive material common to the fastener arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. The adhesive layer 1121 can have a thickness of about 1 to 50 microns, such as about 7 to 15 microns. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C.

The adhesive layer 1121 can have a thickness T_{AL} of between about 1 micron to about 80 microns, such as between about 10 microns and about 50 microns, such as between about 20 microns and about 40 microns. In a number of embodiments, the adhesive layer 1121 may have a thickness T_{AL} of between about 3 and 20 microns. In a number of embodiments, the adhesive layer 1121 may have a thickness T_{AL} of between about 10 and 60 microns. It will be further appreciated that the thickness T_{AL} of the adhesive layer 1121 may be any value between any of the minimum and maximum values noted above. The thickness of the adhesive layer 1121 may be uniform, i.e., a thickness at a first location of the adhesive layer 1121 can be equal to a thickness at a second location therealong. The thickness of the adhesive layer 1121 may be non-uniform, i.e., a thickness at a first location of the adhesive layer 1121 can be different from a thickness at a second location therealong.

FIG. 2C includes an illustration of an alternative embodiment of the composite material that may be formed according to first step 12 and second step 14 of the forming process 10 for producing a push-on fastener in accordance with an embodiment described above. For purposes of illustration, FIG. 2C shows the layer by layer configuration of a composite material 1003 after second step 14. According to this particular embodiment, the composite material 1003 may be similar to the composite material 1002 of FIG. 2B, except this composite material 1003 may also include at least one corrosion protection layer 1704, 1705, and 1708, and a corrosion resistant coating 1124 that can include an adhesion promoter layer 1127 and an epoxy layer 1129 that may couple to the substrate 1119 (i.e., the base material provided in the first step 12) and a low friction layer 1104 (i.e., the low friction coating applied in second step 14).

The substrate 1119 may be coated with corrosion protection layers 1704 and 1705 to prevent corrosion of the composite material 1003 prior to processing. Additionally, a corrosion protection layer 1708 can be applied over layer 1704. Each of layers 1704, 1705, and 1708 can have a thickness of about 1 to 50 microns, such as about 7 to 15 microns. Layers 1704 and 1705 can include a phosphate of zinc, iron, manganese, or any combination thereof, or a nano-ceramic layer. Further, layers 1704 and 1705 can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Layer 1708 can include functional silanes, nano-scaled silane based primers, hydrolyzed silanes, organosilane adhesion promoters, solvent/water based silane primers. Corrosion protection layers 1704, 1706, and 1708 can be removed or retained during processing.

The composite material 1003 may further include a corrosion resistant coating 1125. The corrosion resistant coating 1125 can have a thickness of about 1 to 50 microns, such as about 5 to 20 microns, and such as about 7 to 15 microns. The corrosion resistant coating 1125 can include an adhesion promoter layer 1127 and an epoxy layer 1129. The adhesion promoter layer 1127 can include a phosphate of zinc, iron, manganese, tin, or any combination thereof, or a nano-ceramic layer. The adhesion promoter layer 1127 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The epoxy layer 1129 can be a thermal cured epoxy, a UV cured epoxy, an IR cured epoxy, an electron beam cured epoxy, a radiation cured epoxy, or an air cured epoxy. Further, the epoxy layer 1129 can include polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy layer 1129 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof.

In an embodiment, under step 14 of FIG. 1, any of the layers on the composite material 1000, 1002, 1003, as described above, can each be disposed in a roll and peeled therefrom to join together under pressure, at elevated temperatures (hot or cold pressed or rolled), by an adhesive, or by any combination thereof. Any of the layers of the composite material 1000, as described above, may be laminated together such that they at least partially overlap one another. Any of the layers on the composite material 1000, 1002, 1003, as described above, may be applied together using coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

In an embodiment, the low friction layer 1104 or any layers can be glued to the substrate 1119 using the melt adhesive layer 1121 to form a laminate. In an embodiment, any of the intervening or outstanding layers on the material or composite material 1000, 1002, 1003, may form the laminate. The laminate can be cut into strips or blanks that can be formed into the fastener. The cutting of the laminate may include use of a stamp, press, punch, saw, or may be machined in a different way. Cutting the laminate can create cut edges including an exposed portion of the substrate 1119.

In other embodiments, under step 14 of FIG. 1, any of the layers on the composite material 1000, 1002, 1003, as described above, may be applied by a coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

Referring now to the third step 16 of the forming process 10 as shown in FIG. 1, according to certain embodiments, forming the composite material 1000, 1002, 1003 into a push-on fastener may include a cutting operation. In an embodiment, the cutting operation may include use of a stamp, press, punch, saw, deep draw, or may be machined in a different way. In a number of embodiments, the cutting operation may form a peripheral surface on the push-on fastener. The cutting operation may define a cutting direction initiated from a first major surface to a second major surface, opposite the first major surface, to form the peripheral surfaces or edges. Alternatively, the cutting operation may define a cutting direction initiated from the second major surface to the first major surface to form the peripheral surfaces or edges.

After shaping the push-on fastener, the push-on fastener may be cleaned to remove any lubricants and oils used in the forming and shaping process. Additionally, cleaning can prepare the exposed surface of the substrate for the application of the coating. Cleaning may include chemical cleaning with solvents and/or mechanical cleaning, such as ultrasonic cleaning.

Turning now to the push-on fastener formed according to embodiments described herein, for purposes of illustration, FIG. 3A includes a top view illustration of a push-on fastener 100 formed from a blank of material or composite material 1000, 1001, 1002, 1003 as described using the forming process above for producing a push-on fastener in accordance with an embodiment described above. For purposes of illustration, FIG. 3B shows a side view of a push-on fastener 100 formed from a blank of material or composite material 1000, 1001, 1002, 1003 as described using the forming process above for producing a push-on fastener in accordance with an embodiment described above, which can include a push-on fastener body 102 oriented about a central axis A. The push-on fastener body 102 may be formed from a blank as described above and include a substrate 1119 (e.g. spring steel) that may be curved into a ring-like (substantially annular) shape about a central axis A, forming an aperture 180. The push-on fastener body 102 may further include a sliding layer 1104 that conforms to the shape of the annular base 104, as formed as a sliding layer 1104 from the blank of composite material 1000, 1001, 1002, 1003 as described above. The push-on fastener body 102 may further include an annular base 104. The ends of the annular base 104 may not meet (e.g., it may be formed as a split ring), thereby leaving an axial gap adjacent the circumference of the annular base 104. In other embodiments, the annular base 104 may be curved so that the ends overlap with one another. In yet further embodiments, the annular base 104 may be a continuous, unbroken ring. The push-on fastener body 102 may include an inner radial edge 103 and an outer radial edge 105. The inner radial edge or outer radial edge may define a peripheral surface of the push-on fastener 100. The inner radial edge 103 may at least partially define the aperture 180 in the push-on fastener 100. In some embodiments, the push-on fastener 100 may further include at least one radial taper 110 disposed along at least one of the inner radial edge 103 or the outer radial edge 105 of the annular base 104.

In a number of embodiments, as shown in FIG. 3A, the push-on fastener 100 may have an overall outer radius OR_{W}. For purposes of embodiments described herein, the outer radius OR_{W} of the push-on fastener 100 is the distance from the central axis A to the outer radial edge 105. According to certain embodiment, the outer radius OR_{W} of the push-on fastener 100 may be at least about 1 mm, such as, at least about 10 mm or at least about 20 mm or at least about 30 mm or at least about 40 mm or even at least about 50 mm. According to still other embodiments, the outer radius OR_{W} of the push-on fastener 100 may be not greater than about 100 mm, such as, not greater than about 50 mm or even not greater than about 25 mm. It will be appreciated that the outer radius OR_{W} of the push-on fastener 100 may be within a range between any of the minimum and maximum values noted above. It will be further appreciated that the outer radius OR_{W} of the push-on fastener 100 may be any value between any of the minimum and maximum values noted above. For example, the outer radius OR_{W} of the push-on fastener 100 may be 7.5 mm.

In a number of embodiments, as shown in FIG. 3A, the push-on fastener 100 may have an overall inner radius IR_{W}. For purposes of embodiments described herein, the inner radius IR_{W} of the push-on fastener 100 is the distance from the central axis A to the inner radial edge 103. According to certain embodiment, the inner radius IR_{W} of the push-on fastener 100 may be at least about 1 mm, such as, at least about 10 mm or at least about 20 mm or at least about 30 mm or at least about 40 mm or even at least about 50 mm. According to still other embodiments, the inner radius IR_{W} of the push-on fastener 100 may be not greater than about 100 mm, such as, not greater than about 50 mm or even not greater than about 25 mm. It will be appreciated that the inner radius IR_{W} of the push-on fastener 100 may be within a range between any of the minimum and maximum values noted above. It will be further appreciated that the inner radius IR_{W} of the push-on fastener 100 may be any value between any of the minimum and maximum values noted above. For example, the inner radius IR_{W} of the push-on fastener 100 may be 4 mm. The inner radius IR_{W} may coincide with the radius of the aperture 180.

For purposes of illustration, FIG. 3B includes a cross-sectional view of a push-on fastener 100, as shown in FIG. 3A, in accordance with embodiments described herein. As shown in FIG. 3B, the annular base 104 can include a first axial surface 106 and a second axial surface 107 opposite the first axial surface 106 oriented down the central axis A and spaced apart by a axial height T_{AB}. At least one of the first axial surface 106 or second axial surface 107 may form a major surface of the push-on fastener 100. The first axial surface 106 may have a sliding layer 1104 that conforms to the shape of the annular base 104 with the substrate 1119, as formed from the composite material 1000, 1001, 1002, 1003 as described above. Alternatively or additionally, the second axial surface 107 may have a sliding layer 1104 that conforms to the shape of the annular base 104, as formed from the composite material 1000, 1001, 1002, 1003 as described above. In other embodiments, the sliding layer 1104 may be laminated onto both surfaces of the annular base 104. The annular base 104 may have a polygonal, oval, circular, semi-circular, or substantially circular cross-section when viewed in a plane perpendicular to the central axis A.

In a number of embodiments, the push-on fastener 100 may have a particular axial height T_{W}. For purposes of embodiments described herein and as shown in FIG. 3B, the axial height T_{W} of the push-on fastener 100 is the distance from the first axial surface 106 to the second axial surface 107. According to certain embodiment, the axial height T_{W} of the a push-on fastener 100 may be at least about 0.01 mm, such as, at least about 0.1 mm or at least about 0.2 mm or at least about 0.3 mm or at least about 0.4 mm or even at least about 0.5 mm. According to still other embodiments, the axial height T_{W} of the a push-on fastener 100 may be not greater than about 10 mm, such as, not greater than about 5 mm or even not greater than about 1 mm. It will be appreciated that the axial height T_{W} of the push-on fastener 100 may be within a range between any of the minimum and maximum values noted above. It will be further appreciated that the axial height T_{W} of the push-on fastener 100 may be any value between any of the minimum and maximum values noted above. For example, the axial height T_{W} of the push-on fastener 100 may be 1.3 mm.

Referring back to FIG. 3A, the push-on fastener 100 may include at least one radial taper 110. In a number of embodiments, the radial taper 110 may run the entire circumference of the push-on fastener 100. According to yet other embodiments, the at least one radial taper 110 may project radially inwardly from the annular base 104. According to yet other embodiments, the at least one radial taper 110 may project radially outwardly from the annular base 104.

In an embodiment, as shown in FIG. 3B, the at least one radial taper 110 can include a bridge portion 135 connecting the at least one radial taper 110 to the annular base 104. In certain embodiments, the bridge portion 135 can cant relative to the central axis A. As stated above and now shown in FIG. 3B, the bridge portion 135 can form an angle α with respect to the plane parallel to the annular base 104 and perpendicular to the central axis A. By way of a non-limiting embodiment, the angle α between the bridge portion 135 and the annular base 104 in the unloaded state can be at least 0.1°, such as at least 2°, at least 4°, at least 5°, or even at least 10°. In another embodiment, the angle α can be no greater than 45°, such as no greater than 40°, no greater than 35°, no greater than 30°, no greater than 25°, or even no greater than 20°. In still another embodiment, the angle α can be no less than or equal to 30°. It will be appreciated that the angle α may be within a range between any of the minimum and maximum values noted above. It will be further appreciated that the angle α may be any value between any of the minimum and maximum values noted above. For example, the angle α may be 43°.

In a number of embodiments, the angles α of the radial taper 110 can all be uniform. In another embodiment, an angle α of at least one radial taper 110 may differ. In a particular embodiment, each angle α can be no less than 60°, such as no less than 90°, no less than 120°, or even no less than 150°. In a further embodiment, each angle α can be less than 180°, such as no greater than 170°, no greater than 160°, no greater than 150°, no greater than 140°, no greater than 130°, no greater than 120°, or even no greater than 110°. In a particular embodiment, the angles α can all lie along straight lines that extend in a substantially parallel direction. As used herein, “substantially parallel direction” refers to a deviation of no greater than 5° between the measured directions of two lines, such as no greater than 4°, no greater than 3°, or even no greater than 2°. In a more particular embodiment, the angles α can all lie along lines that extend in parallel. As used herein, “extend in parallel” refers to a deviation of no greater than 0.5° between the measured directions of two lines.

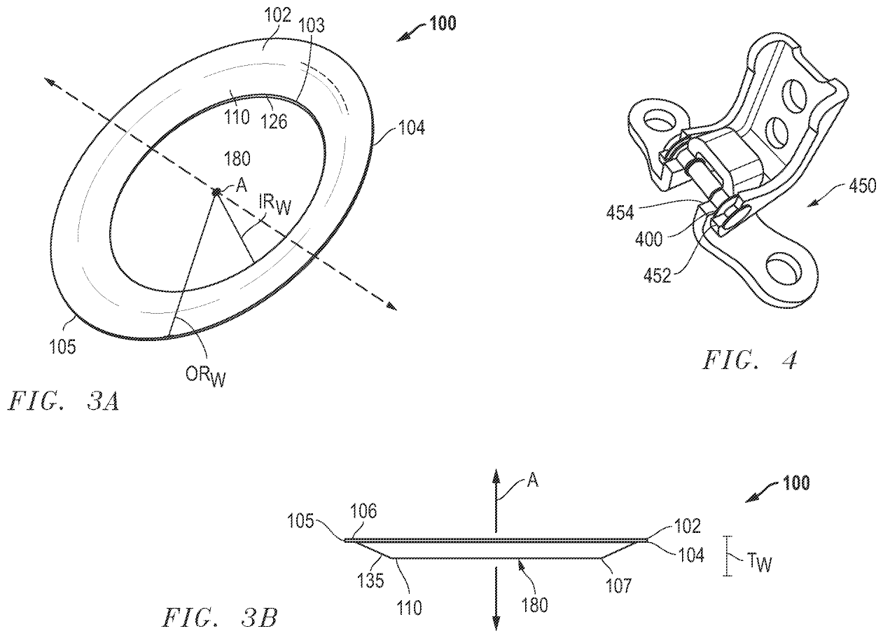

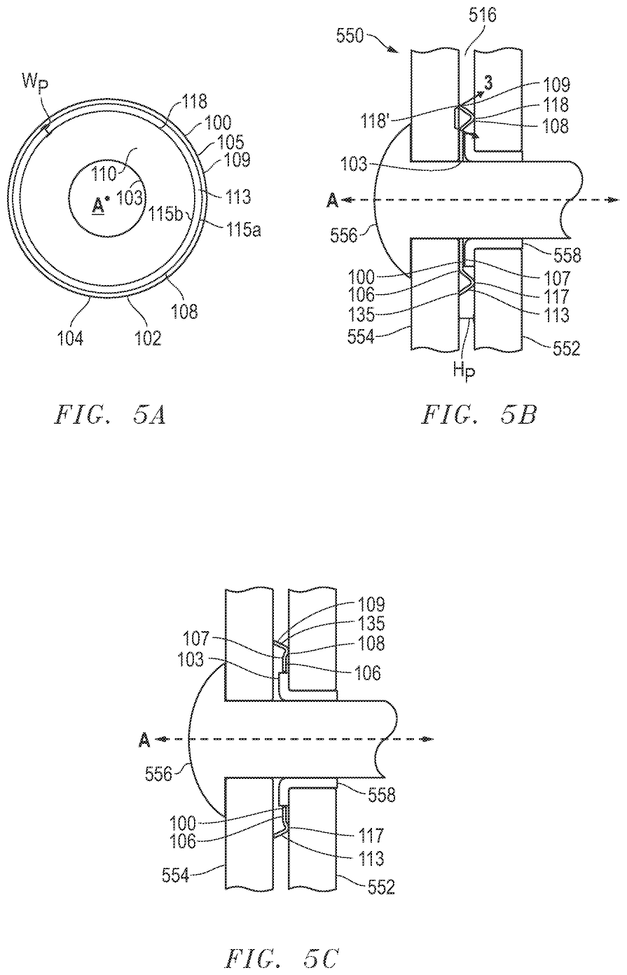

For purposes of illustration, FIG. 4 includes a top perspective view of a push-on fastener 100 within an assembly 450 in accordance with embodiments described above and herein. It will be appreciated that corresponding components between FIG. 4 (i.e., components having the same reference number) may be described as having any of the characteristics or features described in reference to any of the other figures disclosed herein. In a number of embodiments, the push-on fastener 100 can be disposed adjacent to, or contacting, an inner component 452 (such as a bearing, housing, a side member, or other structural member) in an assembly 400. In a number of embodiments, the inner component 452 may be an inner bracket of a hinge assembly as discussed in more detail below. The assembly 400 may also include an outer component 454 (such as a bearing, housing, a side member, or other structural member) fitted on the inner component 452. In a number of embodiments, the outer component 454 may be an outer bracket of a hinge assembly as discussed in more detail below. In an embodiment, the outer component 454 may be adapted to rotate relative to the inner component 452. In another embodiment, the inner component 452 may be adapted to rotate relative to the outer component 454. The push-on fastener 100 can be disposed adjacent to, or contacting, an inner component 452 in an assembly 450. In a number of embodiments, the push-on fastener 100 may be installed on the inner component 452 in the assembly 400. The push-on fastener 100 can be disposed adjacent to, or contacting, an outer component 454 in an assembly 450. In a number of embodiments, the push-on fastener 100 may be installed on the outer component 454 in the assembly 450.

For purposes of illustration, FIG. 5A includes a top view of a push-on fastener 100 in accordance with embodiments described above and herein. For purposes of illustration, FIG. 5B includes a side view of a push-on fastener 100 within an assembly 100 in accordance with embodiments described above and herein. For purposes of illustration, FIG. 5C includes a side view of a push-on fastener 100 within an assembly 550 in accordance with embodiments described above and herein. It will be appreciated that corresponding components between FIGS. 5A-5C (i.e., components having the same reference number) may be described as having any of the characteristics or features described in reference to any of the other figures disclosed herein. As shown in FIGS. 5A-5C, the push-on fastener 100 may have at least one projection 108 projecting axially from the push-on fastener body 102 relative to the central axis A. The at least one projection 108 may projecting axially inward from the push-on fastener body 102 relative to the central axis A. The at least one projection 108 may projecting axially outward from the push-on fastener body 102 relative to the central axis A. The projection may be continuous around the circumference of the annular base 104 (e.g. wave) or discontinuous around the circumference of the annular base 104 (e.g. dimple) as discussed in more detail below. The push-on fastener 100 may include a plurality of projections 108 that extend radially inward or outward from the first axial surface 106 and/or the second axial surface 108 of the push-on fastener 100. The projections 108 may be adapted to contact a mating component. For example, FIG. 5A shows the projections 108 extending radially outward in the form of a circumferential wave extending in the axial direction.

The projections 108 may be formed from the composite material 1000, 1001, 1002, 1003 via stamping (e.g., pressed using a suitably shaped mold, rotary wave forming, etc.) or via another method. There may be a flat, circumferentially extending rim 109 of composite material at least one axial end 103, 105 of the push-on fastener 100 above or below the projections 108. Each projection 108 also may be spaced from its neighboring projections 108 by an unformed section 110, which may be contiguously formed with rims 109 and spaced circumferentially, radially, or axially between a first pair of adjacent projections 108, as discussed in further detail below. The projections 108 may be axially-elongated ridges (i.e. circumferential waves). In an embodiment, the projection may be rounded or rectilinear. In an embodiment, at least two of the projections 108 may have the same geometric shape or size as compared to each other. In a further embodiment, all of the projections 108 may have the same geometric shape or size as compared to each other. In another embodiment, at least one of the projections 108 may have different geometric shapes or sizes as compared to each other. In a further embodiment, all of the projections 108 may have different geometric shapes or sizes as compared to each other.

As shown in FIGS. 5A-5C, at least one of the projections 108 may have a circumferential width, W_{P}, defined between a pair of bases 115a, 115b, and a radial height H_{P}, and a circumferential hump 113 extending in the radial direction, the hump 113 rising to and falling from an apex 117 within the circumferential width, W_{P}. The apex 117 of the at least one projection 108 may be rounded or squared. The circumferential width, W_{P}, may be any value within the overall inner radius IR_{W} and the overall outer radius OR_{W} of the push on fastener 100 described above. The radial height, H_{P}, may be any value within the radial height T_{W} of the push on fastener 100 described above.

In operation, the push-on fastener 100 may be located adjacent to an opposing component within an assembly 550, as shown in FIGS. 5B-5C. In operation, the push-on fastener 100 may be located in an axial gap 516 between two opposing (mating) components. For example, it may be located in the annular space between an inner component 552 and an outer component 554 as described above. The projections 108 may be compressed between the inner and outer components. In some embodiments, each projection 108 may act as a spring and deforms to fit the components together with zero clearance therebetween. In other words, the inner component contacts the inner surfaces 106 of the push-on fastener 100 and the outer component contacts the outer surfaces 107 of the push-on fastener 100. In a number of embodiments, at least one projection 108 may have a spring rate of not greater than 30 kN/mm, such as not greater than 25 kN/mm, such as not greater than 15 kN/mm, or such as not greater than 10 kN/mm. In a number of embodiments, at least one projection 108 may have a spring rate of at least 10 N/mm, such as at least 100 N/mm, or such as at least 500 N/mm. The spring rate may vary depending on the size of the projection 108, the thickness of the push-on fastener 100, and other dimensions of the push-on fastener 100 as described further below. Further, the assembly can include a shaft 556 and, optionally, a bearing 558 located between the inner component 552 and outer component 554. The shaft 556 may fix the assembly 550 together and may be disposed within the aperture 180 of the push-on fastener 100. The bearing 558 may provide ease of use for movement within the assembly 550. In FIG. 5B, the inner radial edge 103 of the push-on fastener 100 may contact or be in close proximity to the shaft 556, according to a number of embodiments. In FIG. 5C, the inner radial edge 103 of the push-on fastener 100 may contact or be in close proximity to the bearing 558, according to a number of embodiments.

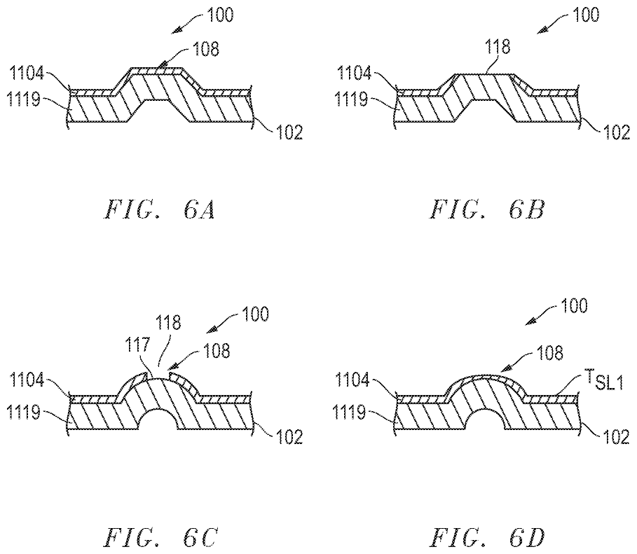

FIGS. 6A-6D include enlarged sectional end views of embodiments of a layer structure of a push-on fastener taken along the exemplary line 3-3 of FIG. 5B, showing the push-on fastener in various configurations. FIGS. 6A-6D include similar features as shown in FIGS. 3A-3B and labeled as such. For a description of those elements, please refer to the prior description of FIGS. 3A-3B. In a number of embodiments, as shown in exemplary FIG. 6A, the push-on fastener 100, 200 may include a projection 108 that may have a sliding layer 1104. This may be called an uninstalled configuration. In a number of embodiments, as shown in exemplary FIG. 6B, the push-on fastener 100 may include a projection 108 that include at least one void area 118 that is free of the sliding layer 104. The void area 118 can be located at a point of contact between the push-on fastener 100 and at least one of the inner component or the outer component, which enables the push-on fastener 100 to be electrically conductive and provide electrical conductivity between the fastener and a neighboring component (e.g. the inner component or the outer component) when disposed in an assembly. Generally, the inner component and the outer component may be electrically conductive. This may allow conductivity between the push-on fastener 100 and at least one of the inner component or the outer component and may be called an installed configuration. The void area 118 may be located at or near the apex 117 of the projection 108. For example, as shown in FIG. 6B or FIG. 6C, some of the sliding layer 1104 may be removed prior to installation or scraped off during installation by one of the inner and outer components. The geometries for facilitating the removal of these materials may include configuring the diameters of the push-on fastener 100 and projection 108 and the parameters of the axial gap with respect to the inner and outer components and the application. For example, the outer diameter of the projection 108 may be slightly greater than the inner diameter of the outer component. Similarly, the inner diameter of the projection 108 may be slightly less than the outer diameter of the inner component. It may be contemplated that the push-on fastener 100 may have the low friction layer 1104 removed to form the void area 118 in other ways prior to installation between the inner component and the outer component. It is also contemplated herein that a void area 118 may be located anywhere on the surface of the push-on fastener 100.

In a number of embodiments, as shown in exemplary FIG. 6D, the push-on fastener 100 may include a projection 108 that have a sliding layer 1104 similar to FIG. 6A. In some embodiments, the push-on fastener 100 may have a first thickness T_{SL1} of the sliding layer 1104 at a first location and a second thickness T_{SL2} of the sliding layer 1104 at a first location. In some embodiments, the first thickness T_{SL1} of the sliding layer 1104 may be at one of the bases 115a, 115b, of the projection 108. In some embodiments, the second thickness T_{SL2} of the sliding layer 1104 may be at or near the apex 117 of the projection 108. In a number of embodiments, the thickness of the sliding layer at a circumferential base of the projection 115a, 115b (i.e. the first location, T_{SL1}) may be at least 2 times greater than the thickness of the sliding layer at the apex of the projection such that the sliding layer at or near the apex of the projection 117 (i.e. the second location, T_{SL2}). In this embodiment, the sliding layer 1104 at or near the apex 117 of the projection 108 would be removed upon application of a sheer force to remove the sliding layer 1104 from the substrate 1119 to create the void area 118.

The first thickness T_{SL1} of the sliding layer 1104 at a circumferential base 115a, 115b of the projection 108 may be at least 2 times greater than the second thickness T_{SL2} of the sliding layer 1104 may be at or near the apex 117 of the projection 108 such that the sliding layer 1104 at the apex 117 of the projection 108 may be removed upon application of a sheer force to remove the sliding layer 1104 from the substrate 1119. In some embodiments, the first thickness T_{SL1} of the sliding layer 1104 at a circumferential base 115a, 115b of the projection 108 may be at least 3 times greater, such as 6 times greater, such as at least 8 times greater, or such as at least 10 times greater than the second thickness T_{SL2} of the sliding layer 1104 may be at or near the apex 117 of the projection 108, 208 such that the sliding layer 1104 at the apex 117 of the projection 108 may be removed upon application of a sheer force to remove the sliding layer 1104 from the substrate 1119.

In some embodiments, the void area 118 may have a surface area of greater than 0.1 mm², greater than 1 mm², such as greater than 2 mm², such as greater than 5 mm², such as greater than 20 mm², or such as greater than 50 mm². In some embodiments, the void area 118 may have a surface area of less than 100 mm² such as less than 30 mm², such as less than 10 mm², such as less than 5 mm², or such as less than 1 mm². It will be further appreciated that the void area 118 may have a surface area that may be any value between any of the minimum and maximum values noted above. It can also be appreciated that the void area 118 may have a surface area that may vary along its axial length or circumferential width and may vary across a plurality of push-on fasteners.

In this way, in some embodiments, the push-on fastener 100 may have an uninstalled configuration or in an interim state of manufacture (see, e.g., FIG. 6A) where the push-on fastener 100 may be electrically non-conductive or low-conductive, and an installed configuration (see, e.g., FIG. 6B) where the fastener may be electrically conductive. For example, the uninstalled configuration or interim manufactured state may have an electrical resistivity that may be greater than 10 MΩ, and the installed configuration may have an electrical resistivity that may be less than 1Ω (e.g., about 0 to 0.5Ω). Resistivity is measured from a first axial surface/first major surface 106 of the push-on fastener 100 to a second axial surface/second major surface 107 of the push-on fastener 100 along a radially extending line substantially parallel to the central axis A that intersects the push-on fastener 100 at which the void area is to be formed. In some embodiments, having a resistivity of less than 1Ω may be defined as being non-conductive while having a resistivity of greater than 1Ω may be defined as being conductive.

In some embodiments, projections 108 may extend both radially inward and radially outward relative to the fastener body 102. In some embodiments, at least one projection 108 may extend both radially inward and radially outward relative to the fastener body 102 of a single push-on fastener 100 (not shown). The installed configuration may include projections 108 that may be at least partially void of the sliding layer 1104 (see, e.g., FIG. 6B), such that the push-on fastener 100 may be electrically conductive through the projections 108. Referring back to FIG. 5B, the push-on fastener 100 may include void areas 118, 118′ on both the first axial surface 106 and the second axial surface 107. This may allow conductivity between the inner component 552 and outer component 554 through the push-on fastener 100.

Generally, the method of forming a push-on fastener 100 may generally include: providing a blank including an electrically conductive substrate 1119, and an electrically non-conductive sliding layer 1104 coupled to the substrate 1119; forming a plurality of projections 108 in the blank; forming the blank into a push-on fastener 100 including a conductive, annular push-on fastener body 102 including a major surface and a radial edge defining a peripheral surface 103, 105, and an electrically non-conductive sliding layer 1104 coupled to the major surface 106, 107 of the push-on fastener body 102; and removing sliding layer 1104 from the major surface 106, 107 to form a void area 118 free of non-conductive sliding layer 1104 adapted to contact an inner component 552 or an outer component 554 so as to provide electrical conductivity between the major surface 106, 107 and at least one of the inner component 552 or the outer component 554.

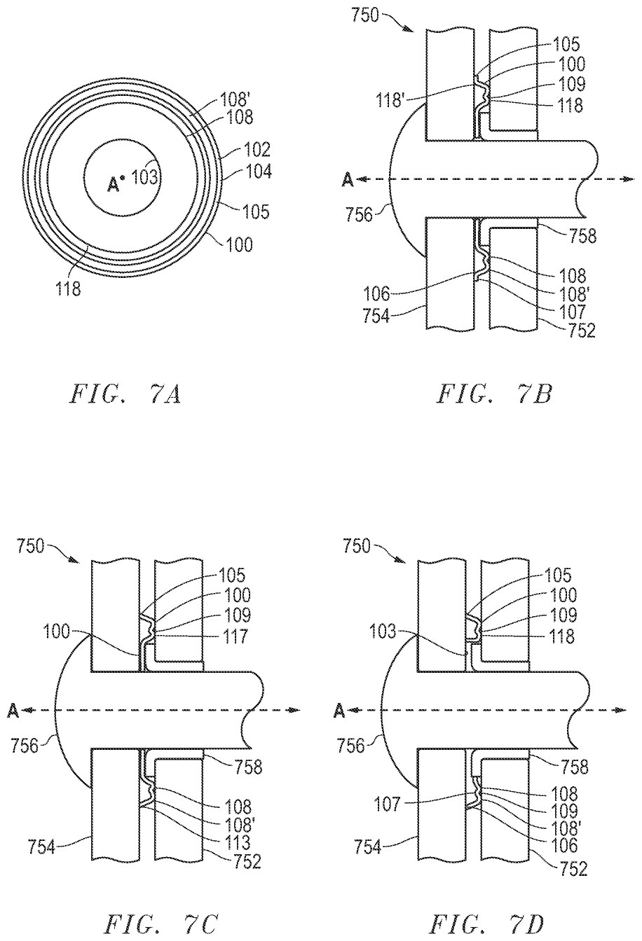

For purposes of illustration, FIG. 7A includes a top view of a push-on fastener 100 in accordance with described herein. For purposes of illustration, FIG. 7B includes a side view of a push-on fastener 100 within an assembly 750 in accordance with embodiments described herein. For purposes of illustration, FIG. 7C includes a side view of a push-on fastener 100 within an assembly 750 in accordance with embodiments described herein. For purposes of illustration, FIG. 7D includes a side view of a push-on fastener 100 within an assembly 750 in accordance with embodiments described herein. It will be appreciated that corresponding components between FIGS. 7A-7D (i.e., components having the same reference number) may be described as having any of the characteristics or features described in reference to any of the other figures disclosed herein. As shown in FIGS. 7A-7D, the push-on fastener 100 may have at least one projection 108 projecting from the annular base 104, as mentioned above. In addition, the push on fastener 100 may include a second projection 108′ in the form of a second circumferential wave. The second projection 108′ may maintain its low friction layer (lack a void area) and act as a sealing wave that works as a seal to prevent contamination of the assembly 750. The area between the first projection 108 and the second projection 108′ may be a ridge 109 that is elevated from the plane of the rest of the annular base 104. In the embodiment shown in FIG. 7B, the outer radial edge 105 may be flat (e.g. in a substantially similar plane with the annular base 104). In the embodiment shown in FIG. 7C, the outer radial edge 105 may be part of the hump 113 of the projection 108. In the embodiment shown in FIG. 7D, the outer radial edge 105 and the inner radial edge 103 may be part of the hump 113 of a projection 108. In a number of embodiments, the sliding layer may be removed to form at least one void area 118, 118′ free of non-conductive sliding layer adapted to contact an inner component 752 or an outer component 754 so as to provide electrical conductivity between the major surface and at least one of the inner component 752 or the outer component 754.

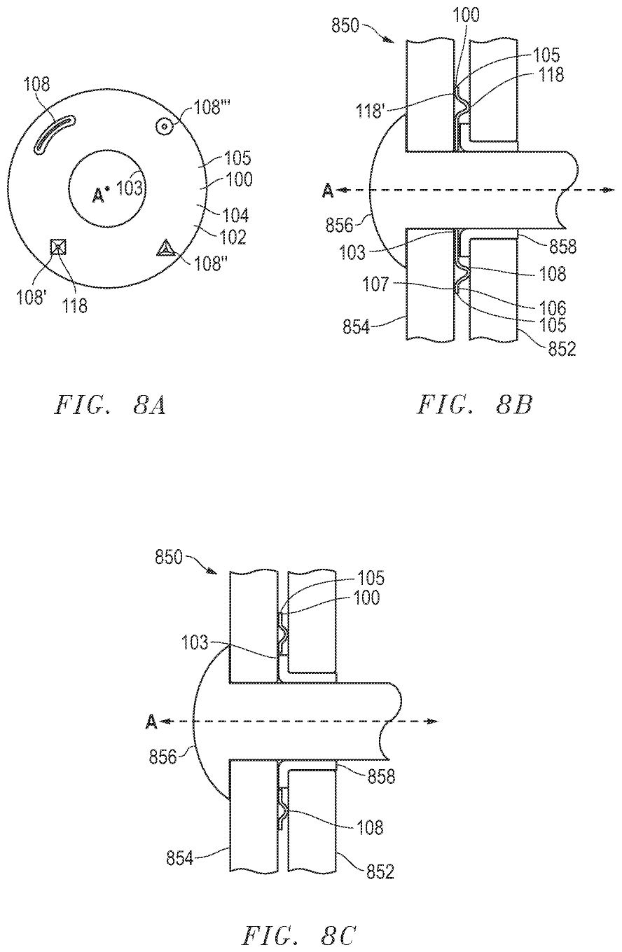

For purposes of illustration, FIG. 8A includes a top view of a push-on fastener 100 in accordance with described herein. For purposes of illustration, FIG. 8B includes a side view of a push-on fastener 100 within an assembly 850 in accordance with embodiments described herein. For purposes of illustration, FIG. 8C includes a side view of a push-on fastener 100 within an assembly 850 in accordance with embodiments described herein. It will be appreciated that corresponding components between FIGS. 8A-8C (i.e., components having the same reference number) may be described as having any of the characteristics or features described in reference to any of the other figures disclosed herein. As shown in FIGS. 8A-8C, the push-on fastener 100 may have at least one projection 108 projecting from the annular base 104, as mentioned above. In a number of embodiments, the at least one projection 108 may include multiple projections 108, 108′, 108″, 108′″. The at least one projection 108 may be in the form of a dimple. In a number of embodiments, the at least one projection or dimple 108 may have a polygonal cross-section from the central axis A. The at least one projection or dimple 108 may include at least one polygonal angle. For example, at least one of the projections 108 may have an arcuate portion in the form of a discontinuous wave, as shown in FIG. 8A. In other embodiments, as shown best in FIG. 8A, the at least one projection or dimple 108′, 108″ may include a triangle or a quadrilateral shape extending from the generally annular base 104. In another embodiment, the at least one projection or dimple 108′″ may have a semi-circular cross-section from the central axis A, as shown in FIG. 8A. In another embodiment, the at least one projection or dimple 108 may have a variable cross-section from the central axis A. In FIG. 8B, the inner radial edge 103 of the push-on fastener 100 may contact or be in close proximity to the shaft 856, according to a number of embodiments. In FIG. 8C, the inner radial edge 103 of the push-on fastener 100 may contact or be in close proximity to the bearing 858, according to a number of embodiments. In a number of embodiments, the sliding layer may be removed to form at least one void area 118, 118′ free of non-conductive sliding layer adapted to contact an inner component 852 or an outer component 854 so as to provide electrical conductivity between the major surface and at least one of the inner component 852 or the outer component 854.

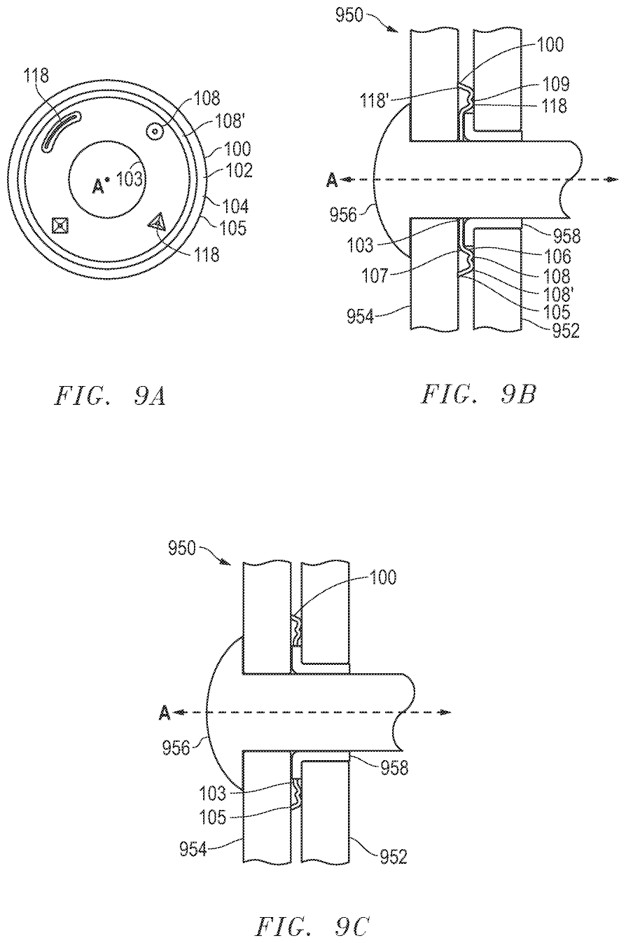

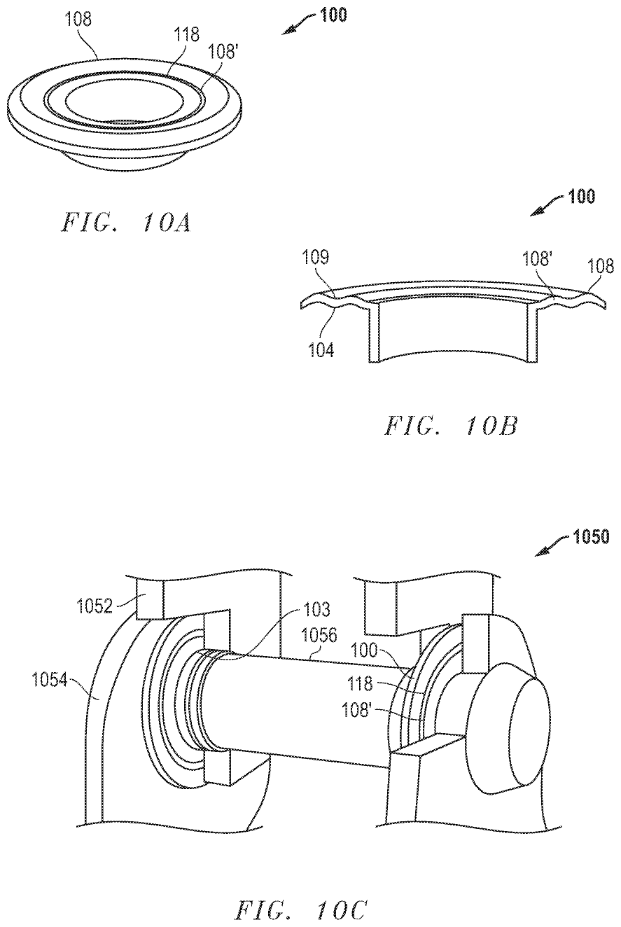

For purposes of illustration, FIG. 9A includes a top view of a push-on fastener 100 in accordance with described herein. For purposes of illustration, FIG. 9B includes a side view of a push-on fastener 100 within an assembly 950 in accordance with embodiments described herein. For purposes of illustration, FIG. 9C includes a side view of a push-on fastener 100 within an assembly 950 in accordance with embodiments described herein. It will be appreciated that corresponding components between FIGS. 9A-9C (i.e., components having the same reference number) may be described as having any of the characteristics or features described in reference to any of the other figures disclosed herein. As shown in FIGS. 9A-9C, the push-on fastener 100 may have at least one projection 108 in the form of a dimple projecting from the annular base 104, as mentioned above. In addition, the push on fastener 100 may include a second projection 108′ in the form of a second circumferential wave. The second projection 108′ may maintain its low friction layer (lack a void area) and act as a sealing wave that works as a seal to prevent contamination of the assembly 950. The area between the first projection 108 and the second projection 108′ may be a ridge 109 that is elevated from the plane of the rest of the annular base 104. In FIG. 9B, the inner radial edge 103 of the push-on fastener 100 may contact or be in close proximity to the shaft 956, according to a number of embodiments. In FIG. 9C, the inner radial edge 103 of the push-on fastener 100 may contact or be in close proximity to the bearing 958, according to a number of embodiments. In a number of embodiments, the sliding layer may be removed to form at least one void area 118, 118′ free of non-conductive sliding layer adapted to contact an inner component 952 or an outer component 954 so as to provide electrical conductivity between the major surface and at least one of the inner component 952 or the outer component 954.

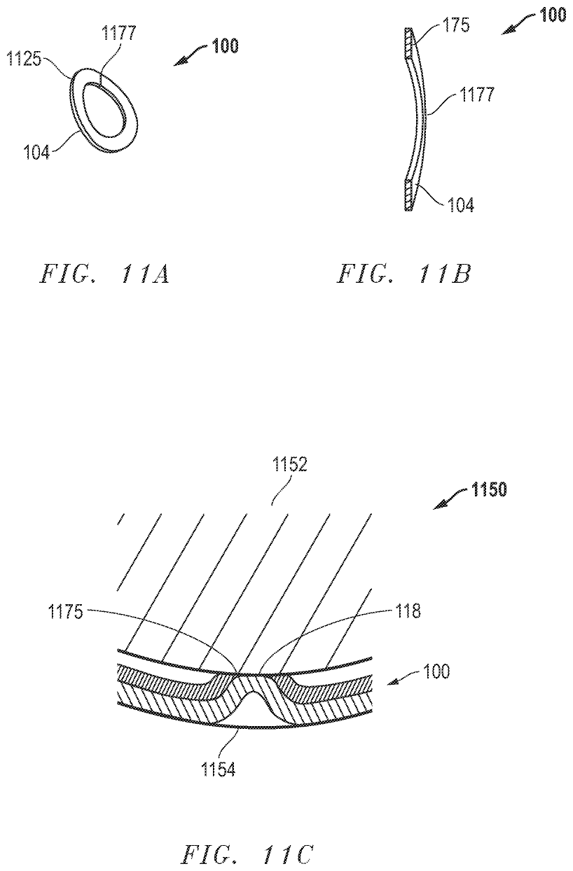

For purposes of illustration, FIG. 10A includes a top view of a push-on fastener 100 in accordance with described herein. For purposes of illustration, FIG. 10B includes a side cut-away view of a push-on fastener 100 in accordance with embodiments described herein. For purposes of illustration, FIG. 9C includes a side view of a push-on fastener 100 within an assembly 1050 in accordance with embodiments described herein. It will be appreciated that corresponding components between FIGS. 10A-10C (i.e., components having the same reference number) may be described as having any of the characteristics or features described in reference to any of the other figures disclosed herein. As shown in FIGS. 10A-10C, the push-on fastener 100 may have at least one projection 108 in the form of a ridge or circumferential wave projecting from the annular base 104, as mentioned above. In addition, the push on fastener 100 may include a second projection 108′ in the form of a second circumferential wave. The second projection 108′ may maintain its low friction layer (lack a void area) and act as a sealing wave that works as a seal to prevent contamination of the assembly 1050. The area between the first projection 108 and the second projection 108′ may be a ridge 109 that is elevated from the plane of the rest of the annular base 104. In FIG. 1C, the inner radial edge 103 of the push-on fastener 100 may contact or be in close proximity to the shaft 1056, according to a number of embodiments. In a number of embodiments, the sliding layer may be removed to form at least one void area 118 free of non-conductive sliding layer adapted to contact an inner component 1052 or an outer component 1054 so as to provide electrical conductivity between the major surface and at least one of the inner component 1052 or the outer component 1054. This embodiment may eliminate the need for a bearing as the void area 118 on the inner circumferential wave 108′ provides conductivity while the outer wave 108 prevents contamination.

For purposes of illustration, FIG. 11A includes a top view of a push-on fastener 100 in accordance with described herein. For purposes of illustration, FIG. 11B includes a side view of a push-on fastener 100 in accordance with embodiments described herein. For purposes of illustration, FIG. 9C includes a side view of a push-on fastener 100 within an assembly 1150 in accordance with embodiments described herein. It will be appreciated that corresponding components between FIGS. 9A-9C (i.e., components having the same reference number) may be described as having any of the characteristics or features described in reference to any of the other figures disclosed herein. As shown in FIGS. 11A-11C, the push-on fastener 100 may have a wave appearance including at least one hill 1175 and at least one valley 1177 projecting from the annular base 104. This may allow the push-on fastener 100 to have an arcuate shape. As shown in FIG. 11C, the hill 1175 may be elevated from the plane of the rest of the annular base 104 and may contact or be in close proximity to the shaft 1152, according to a number of embodiments. In a number of embodiments, the sliding layer may be removed to form at least one void area 118 free of non-conductive sliding layer adapted to contact an inner component 1152 or an outer component 1154 so as to provide electrical conductivity between the major surface and at least one of the inner component 1152 or the outer component 1154. In an embodiment, the hill 1175 may have a void area 118 to contact the inner component 1152 or outer component 1154. Alternatively, the valley 1177 may have a void area to contact the inner component 1152 or outer component 1154. As shown in FIG. 11C, the hill 1175 may have a void area 118 to contact the inner component 1152.

According to embodiments herein, a method of assembly is shown. The method may include providing an inner component, an outer component, and a push-on fastener 100 that is electrically non-conductive, where the push-on fastener 100 includes: a conductive, annular push-on fastener body 102 including a major surface 106, 107 and a radial edge 103, 105 defining a peripheral surface, the push-on fastener body 102 forming an aperture 180 defining a central axis A, and a non-conductive sliding layer 1104 overlying the major surface 106, 107, where the major surface 106, 107 includes a void area 118 free of non-conductive sliding layer 1104; joining the push-on fastener 100 to one of the inner and outer components to form a sub-assembly; and joining the other of the inner and outer components to the sub-assembly to form an assembly, and forming an electrically conductive path between the inner component, the push-on fastener 100, and the outer component, where electrically conductive is defined as having an electrical resistivity value of less than 10 Ω·m measured from the major surface 106, 107 of the push-on fastener 100 to a second major surface 106, 107 of the push-on fastener 100 along an axially extending line substantially parallel to the central axis A.

The assembly may in some embodiments be an exemplary hinge assembly, such as an automotive door hinge, hood hinge, tailgate hinge, engine compartment hinge, and the like. The hinge assembly may be used within a vehicle. Such assemblies may be used to provide an electrically conductive circuit between the inner component, the push-on fastener, the outer component, the shaft, and/or the bearing and may have portions of the sliding layer removed before or during installation of the inner component into the push-on fastener such that the push-on fastener is disposed between the inner component and the outer component.

Applications for embodiments include, for example, assemblies for hinges and other vehicle components. Further, use of the push-on fastener or assembly may provide increased benefits in several applications such as, but not limited to, door, hood, tailgate, and engine compartment hinges, seats, steering columns, flywheels, driveshaft assemblies, powertrain applications (such as belt tensioners), or other types of applications. According to particular embodiments herein, the push-on fastener may provide electrical conductivity in assemblies with inner and outer components including antennas that may solve or reduce RFI (radio frequency interference) issues. The use of these push-on fasteners may replace existing cable solutions. In addition, push-on fasteners according to embodiments herein may decrease noise/vibration, reduce wear of the push-on fastener surface and the mating components and reduce complex componentry and assembly time, thereby increasing lifetime, improving visual appearance, and improving effectiveness and performance of the assembly, the push-on fastener, and its other components.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A push-on fastener comprising: a conductive, annular push-on fastener body comprising a major surface and a radial edge defining a peripheral surface, the push-on fastener body forming an aperture defining a central axis; and a non-conductive sliding layer overlying the major surface of the push-on fastener body, wherein the major surface comprises a void area free of non-conductive sliding layer adapted to contact an inner component or an outer component so as to provide electrical conductivity between the push-on fastener and a neighboring component.

Embodiment 2: An assembly comprising: an outer component; an inner component; and a push-on fastener disposed between inner component and outer component, wherein the push-on fastener comprises: a conductive, annular push-on fastener body comprising a major surface and a radial edge defining a peripheral surface, the push-on fastener body forming an aperture defining a central axis; and a non-conductive sliding layer overlying the major surface of the push-on fastener body, wherein the major surface comprises a void area free of non-conductive sliding layer contacting the inner component or the outer component so as to provide electrical conductivity between the push-on fastener and at least one of the inner component or the outer component.

Embodiment 3: An assembly comprising: an outer component; an inner component; and a push-on fastener disposed between inner component and outer component, wherein the push-on fastener comprises a conductive, annular push-on fastener body comprising a major surface and a radial edge defining a peripheral surface, the push-on fastener body forming an aperture defining a central axis, and an electrically non-conductive sliding layer coupled to the major surface of the push-on fastener body, wherein the push-on fastener has an uninstalled configuration where the push-on fastener is electrically non-conductive, and an installed configuration where the push-on fastener is electrically conductive, wherein electrically non-conductive is defined as having an electrical resistivity value of greater than 10 Ω·m measured from the major surface of the push-on fastener to a second major surface of the push-on fastener along an axially extending line substantially parallel to the central axis.

Embodiment 4: A method of forming and installing a push-on fastener, comprising: providing an inner component, and an outer component, and a push-on fastener that is electrically non-conductive, wherein the push-on fastener comprises: a conductive, annular push-on fastener body comprising a major surface and a radial edge defining a peripheral surface, the push-on fastener body forming an aperture defining a central axis, and a non-conductive sliding layer overlying the major surface, wherein the major surface comprises a void area free of non-conductive sliding layer; joining the push-on fastener to one of the inner and outer components to form a sub-assembly; and joining the other of the inner and outer components to the sub-assembly to form an assembly, and forming an electrically conductive path between the inner component, the push-on fastener, and the outer component, wherein electrically conductive is defined as having an electrical resistivity value of less than 10 Ω·m measured from the major surface of the push-on fastener to a second major surface of the push-on fastener along an axially extending line substantially parallel to the central axis.

Embodiment 5: A method of forming a push-on fastener, comprising: providing a blank comprising an electrically conductive substrate, and an electrically non-conductive sliding layer coupled to the substrate; forming a plurality of projections in the blank; forming the blank into a push-on fastener comprising a conductive, annular push-on fastener body comprising a major surface and a radial edge defining a peripheral surface, and an electrically non-conductive sliding layer coupled to the major surface of the push-on fastener body; and removing sliding layer from the major surface to form a void area free of non-conductive sliding layer adapted to contact an inner component or an outer component so as to provide electrical conductivity between the major surface and a neighboring component.

Embodiment 6: The push-on fastener, assembly, or method of any one of the preceding embodiments, wherein the push-on fastener body comprises a second major surface comprising a sliding layer.

Embodiment 7: The push-on fastener, assembly, or method of embodiment 6, wherein the second major surface comprises a void area free of non-conductive sliding layer adapted to contact an inner component or an outer component so as to provide electrical conductivity between the push-on fastener and the inner component or the outer component.

Embodiment 8: The push-on fastener, assembly, or method of any one of the preceding embodiments, wherein the major surface of the push-on fastener body comprises least one projection projecting axially relative to the central axis and adapted to contact an inner component or an outer component.

Embodiment 9: The push-on fastener, assembly, or method of embodiment 8, wherein the at least one projection extends axially inward toward the inner component.

Embodiment 10: The push-on fastener, assembly, or method of any one of embodiments 8-9, wherein the at least one projection extends axially outward toward the outer component.

Embodiment 11: The push-on fastener, assembly, or method of any one of embodiments 8-10, wherein the at least one projection comprises the void area free of non-conductive sliding layer.

Embodiment 12: The push-on fastener, assembly, or method of any one of embodiments 8-11, wherein the at least one projection comprises a plurality of projections.

Embodiment 13: The push-on fastener, assembly, or method of any one of embodiments 8-12, wherein the at least one projection comprises a circumferential wave extending in the axial direction, the circumferential wave rising to and falling from an apex along the circumferential wave.

Embodiment 14: The push-on fastener, assembly, or method of embodiment 13, wherein the at least one projection comprises a sealing circumferential wave and a contact circumferential wave.

Embodiment 15: The push-on fastener, assembly, or method of any one of embodiments 8-14, wherein the at least one projection comprises a dimple extending in the axial direction, the dimple rising to and falling from an apex along the dimple.

Embodiment 16: The push-on fastener, assembly, or method of any one of embodiments 8-15, wherein the thickness of the sliding layer at a circumferential base of the projection is at least 2 times greater than the thickness of the sliding layer at the apex of the projection such that the sliding layer at the apex of the projection.

Embodiment 17: The push-on fastener, assembly, or method of embodiment 16, wherein the thickness of the sliding layer at the circumferential base of the projection is at least 3 times greater than the thickness of the sliding layer at an apex of the projection, such as at least 6 times greater than the thickness of the sliding layer at an apex of the projection, such as at least 8 times greater than the thickness of the sliding layer at an apex of the projection, or such as at least 10 times greater than the thickness of the sliding layer at an apex of the projection.

Embodiment 18: The push-on fastener, assembly, or method of any one of the preceding embodiments, wherein the push-on fastener body further comprises unformed sections spaced circumferentially between a first pair of adjacent projections.

Embodiment 19: The push-on fastener, assembly, or method of any one of embodiments 8-18, wherein the void area is located on an apex of the projection.

Embodiment 20: The push-on fastener, assembly, or method of any one of the preceding embodiments, wherein the void area comprises a surface area of no greater than 100 mm².

Embodiment 21: The push-on fastener, assembly, or method of any one of the preceding embodiments, wherein the inner component comprises an inner bracket of a hinge.

Embodiment 22: The push-on fastener, assembly, or method of any one of the preceding embodiments, wherein the outer component comprises an outer bracket of a hinge.

Embodiment 23: The assembly or method of any one of embodiments 2-22, wherein the assembly further comprises a bearing axially disposed between the outer component and the inner component.

Embodiment 24: The assembly or method of embodiment 23, wherein the push-on fastener further comprises a second radial edge comprising a second peripheral surface in contact with the bearing.

Embodiment 25: The assembly or method of any one of embodiments 2-23, wherein the assembly further comprises a shaft axially disposed within the aperture of the push-on fastener.

Embodiment 26: The assembly or method of embodiment 25, wherein the push-on fastener further comprises a second radial edge comprising a second peripheral surface in contact with the shaft.

Embodiment 27: The push-on fastener, assembly, or method of any one of the preceding embodiments, wherein the push-on fastener body comprises a metal.

Embodiment 28: The push-on fastener, assembly, or method of embodiment 27, wherein the metal comprises a carbon steel or stainless steel.

Embodiment 29: The push-on fastener, assembly, or method of any one of the preceding embodiments, wherein the sliding layer comprises a polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.

Embodiment 30: The push-on fastener, assembly, or method of any one of the preceding embodiments, wherein the sliding layer has a thickness within the range of 1 to 500 microns.

Embodiment 31: The push-on fastener, assembly, or method of any one of the preceding embodiments, wherein the push-on fastener has an inner radius within the range of 1 to 100 mm.

Embodiment 32: The push-on fastener, assembly, or method of any one of the preceding embodiments, wherein the push-on fastener has an outer radius within the range of 1 to 100 mm.

Note that not all of the features described above are required, that a region of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of assembly and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A push-on fastener comprising:
a conductive, annular push-on fastener body comprising a major surface and a radial edge defining a peripheral surface, the push-on fastener body forming an aperture defining a central axis; and
a non-conductive sliding layer overlying the major surface of the push-on fastener body, wherein the major surface comprises a void area free of non-conductive sliding layer adapted to contact an inner component or an outer component so as to provide electrical conductivity between the push-on fastener and a neighboring component.

2. An assembly comprising:
an outer component;
an inner component; and
a push-on fastener disposed between inner component and outer component, wherein the push-on fastener comprises:
a conductive, annular push-on fastener body comprising a major surface and a radial edge defining a peripheral surface, the push-on fastener body forming an aperture defining a central axis; and
a non-conductive sliding layer overlying the major surface of the push-on fastener body, wherein the major surface comprises a void area free of non-conductive sliding layer contacting the inner component or the outer component so as to provide electrical conductivity between the push-on fastener and at least one of the inner component or the outer component.

3. An assembly comprising:
an outer component;
an inner component; and
a push-on fastener disposed between inner component and outer component, wherein the push-on fastener comprises a conductive, annular push-on fastener body comprising a major surface and a radial edge defining a peripheral surface, the push-on fastener body forming an aperture defining a central axis, and an electrically non-conductive sliding layer coupled to the major surface of the push-on fastener body, wherein the push-on fastener has an uninstalled configuration where the push-on fastener is electrically non-conductive, and an installed configuration where the push-on fastener is electrically conductive, wherein electrically non-conductive is defined as having an electrical resistivity value of greater than 10 Ω·m measured from the major surface of the push-on fastener to a second major surface of the push-on fastener along an axially extending line substantially parallel to the central axis.

4. The push-on fastener of claim 1, wherein the push-on fastener body comprises a second major surface comprising a sliding layer.

5. The push-on fastener of claim 4, wherein the second major surface comprises a void area free of non-conductive sliding layer adapted to contact an inner component or an outer component so as to provide electrical conductivity between the push-on fastener and the inner component or the outer component.

6. The push-on fastener of claim 1, wherein the major surface of the push-on fastener body comprises least one projection projecting axially relative to the central axis and adapted to contact an inner component or an outer component.

7. The push-on fastener of claim 6, wherein the at least one projection extends axially inward toward the inner component.

8. The push-on fastener of claim 6, wherein the at least one projection extends axially outward toward the outer component.

9. The push-on fastener of claim 6, wherein the at least one projection comprises the void area free of non-conductive sliding layer.

10. The push-on fastener of claim 6, wherein the at least one projection comprises a plurality of projections.

11. The push-on fastener of claim 6, wherein the at least one projection comprises a circumferential wave extending in the axial direction, the circumferential wave rising to and falling from an apex along the circumferential wave.

12. The push-on fastener of claim 11, wherein the at least one projection comprises a sealing circumferential wave and a contact circumferential wave.

13. The push-on fastener of claim 6, wherein the at least one projection comprises a dimple extending in the axial direction, the dimple rising to and falling from an apex along the dimple.

14. The push-on fastener of claim 6, wherein the thickness of the sliding layer at a circumferential base of the projection is at least 2 times greater than the thickness of the sliding layer at the apex of the projection such that the sliding layer at the apex of the projection.

15. The push-on fastener of claim 14, wherein the thickness of the sliding layer at the circumferential base of the projection is at least 3 times greater than the thickness of the sliding layer at an apex of the projection.

16. The push-on fastener of claim 1, wherein the push-on fastener body further comprises unformed sections spaced circumferentially between a first pair of adjacent projections.

17. The push-on fastener of claim 6, wherein the void area is located on an apex of the projection.

18. The push-on fastener of claim 1, wherein the void area comprises a surface area of no greater than 100 mm².

19. The push-on fastener of claim 1, wherein the push-on fastener body comprises a metal.

20. The push-on fastener of claim 1, wherein the sliding layer comprises a polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.
